(19) United States
(12) Patent Application Publication
(10) Pub. No.: US 2024/0371070 A1
(43) Pub. Date: Nov. 7, 2024

(54) GRAPHICS PROCESSING

(71) Applicant: Arm Limited, Cambridge (GB)

(72) Inventors: Jakob Axel Fries, Lund (SE); William Robert Stoye, Cambridge (GB); Richard Edward Bruce, Great Shelford (GB)

(73) Assignee: Arm Limited, Cambridge (GB)

(21) Appl. No.: 18/602,592

(22) Filed: Mar. 12, 2024

(30) Foreign Application Priority Data
May 3, 2023 (GB) 2306551.9

(51) Int. Cl. G06T 15/00; G06T 15/06

(52) U.S. Cl. CPC G06T 15/005; G06T 15/06; G06T 2210/21

(57) ABSTRACT

A graphics processor that is operable to perform ray tracing is disclosed. When it is determined that a ray tracing circuit of the graphics processor may require additional storage space to store test record entries to trace a ray, additional storage space is allocated for the ray tracing circuit to use to store test record entries to trace the ray.

### BACKGROUND

The technology described herein relates to graphics processing systems, and in particular to the rendering of frames (images) for display using ray tracing.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane), is determined based on the object(s) in the scene intersected by the ray passing through the sampling position, and the properties of the surfaces of those objects. The ray tracing calculation is complex, and involves determining, for each sampling position, a set of objects within the scene which a ray passing through the sampling position intersects.

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object 25, e.g. a primitive (which primitives may e.g. be in the form of triangles, but may also comprise other suitable geometric shapes), in the scene is identified. This first intersection will be with the object in the scene closest to the sampling position. A secondary ray in the form of shadow ray 26 may be cast from the first intersection point 24 to a light source 27. Depending upon the material of the surface of the object 25, another secondary ray in the form of reflected ray 28 may be traced from the intersection point 24. If the object is, at least to some degree, transparent, then a refracted secondary ray may be considered.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation.

The Applicants believe that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3A and FIG. 3B show exemplary ray tracing acceleration data structures;

FIG. 4A and FIG. 4B are flow charts illustrating embodiments of a full ray tracing process;

FIG. 5 is a schematic diagram illustrating a “hybrid” ray tracing process;

FIG. 6 shows schematically an embodiment of a graphics processor that can be operated in the manner of the technology described herein;

FIG. 7 shows schematically in more detail elements of a graphics processor that can be operated in the manner of the technology described herein;

FIG. 8A and FIG. 8B show schematically a stack layout that may be used for managing a ray tracing traversal operation in embodiments of the technology described herein;

FIG. 9 is a flow chart illustrating embodiments of a ray tracing traversal operation;

FIG. 10 is a schematic diagram illustrating a storage layout in accordance with embodiments of the technology described herein; and

FIG. 11 is a flow chart illustrating a storage allocation process in accordance with embodiments of the technology described herein.

### DETAILED DESCRIPTION

A first embodiment of the technology described herein comprises a graphics processor that is operable to perform ray tracing, wherein the graphics processor comprises:
storage;
a ray tracing circuit operable to trace rays by performing tests to determine whether the rays intersect geometry representing a scene to be rendered, wherein the ray tracing circuit is operable to use the storage to store test record entries for a ray being traced, wherein each test record entry indicates a test that may need to be performed to trace the ray; and
an allocation circuit operable to:
determine whether the ray tracing circuit may require additional storage space to store test record entries to trace a ray; and
when it is determined that the ray tracing circuit may require additional storage space to store test record entries to trace a ray:
   allocate additional storage space from the storage for the ray tracing circuit to use to store test record entries to trace the ray.

A second embodiment of the technology described herein comprises a method of operating a graphics processor that is operable to perform ray tracing, wherein the graphics processor comprises:
storage; and
a ray tracing circuit operable to trace rays by performing tests to determine whether the rays intersect geometry representing a scene to be rendered, wherein the ray tracing circuit is operable to use the storage to store test record entries for a ray being traced, wherein each test record entry indicates a test that may need to be performed to trace the ray;
the method comprising:
determining whether the ray tracing circuit may require additional storage space to store test record entries to trace a ray; and
when it is determined that the ray tracing circuit may require additional storage space to store test record entries to trace a ray:
   allocating additional storage space from the storage for the ray tracing circuit to use to store test record entries to trace the ray.

The technology described herein is concerned with a graphics processor performing ray tracing. In the technology described herein, the graphics processor comprises a ray tracing circuit that is operable to perform ray tracing, e.g. by traversing a ray tracing acceleration data structure. In embodiments, the ray tracing acceleration data structure comprises a plurality of nodes, with each node of the ray tracing acceleration data structure representing a respective volume.

In embodiments, the ray tracing acceleration data structure is arranged as a hierarchy of nodes representing a hierarchy of volumes, e.g. and in embodiments, the ray tracing acceleration data structure comprises one or more bounding volume hierarchies (BVHs).

In embodiments, the ray tracing circuit tests rays for intersection with volumes that are represented by the nodes of the ray tracing acceleration data structure (e.g. BVH).

In embodiments, the ray tracing circuit maintains, in the (local) storage, a test record to manage its testing operations. Each entry of a test record for a ray indicates a respective test that may need to be performed to trace the ray, e.g. and in embodiments, each entry of a test record for a ray indicates a respective node of the ray tracing acceleration data structure (e.g. BVH) that represents a volume that the ray may need to be tested for intersection with.

Thus, according to an embodiment of the technology described herein, there is provided a graphics processor that is operable to perform ray tracing, wherein the graphics processor comprises:
storage;
a ray tracing circuit operable to trace a ray by traversing a ray tracing acceleration data structure and testing the ray against nodes of the ray tracing acceleration data structure to determine whether the ray intersects volumes that the nodes represent, wherein the ray tracing circuit is operable to use the storage to store test record entries for a ray being traced, wherein each test record entry indicates a node of the ray tracing acceleration data structure that a ray may need to be tested against; and
an allocation circuit operable to:
determine whether the ray tracing circuit may require additional storage space to store test record entries to trace a ray; and
when it is determined that the ray tracing circuit may require additional storage space to store test record entries to trace a ray:
   allocate additional storage space from the storage for the ray tracing circuit to use to store test record entries to trace the ray.

According to an embodiment of the technology described herein, there is provided a method of operating a graphics processor that is operable to perform ray tracing, wherein the graphics processor comprises:
storage; and
a ray tracing circuit operable to trace a ray by traversing a ray tracing acceleration data structure and testing the ray against nodes of the ray tracing acceleration data structure to determine whether the ray intersects volumes that the nodes represent, wherein the ray tracing circuit is operable to use the storage to store test record entries for a ray being traced, wherein each test record entry indicates a node of the ray tracing acceleration data structure that a ray may need to be tested against;
the method comprising:
determining whether the ray tracing circuit may require additional storage space to store test record entries to trace a ray; and
when it is determined that the ray tracing circuit may require additional
   storage space to store test record entries to trace a ray:
allocating additional storage space from the storage for the ray tracing circuit to use to store test record entries to trace the ray.

In embodiments of the technology described herein, as will be discussed in more detail below, for a (each) ray being traced, the ray tracing circuit can store test record entries in a (respective) reserved region of the storage, that in embodiments operates as a stack. Thus, in embodiments, a test record (stack) entry indicating a test (e.g. indicating a node of the ray tracing acceleration data structure (e.g. BVH)) is pushed to the stack (reserved region) for a ray (by the ray tracing circuit) when it is determined that the ray may need to be tested (e.g. against the node), and it is determined (by the ray tracing circuit) which test should next be performed (e.g. which node the ray should next be tested against) by popping a (the top) test record entry from the stack for the ray, and determining that the ray should next be tested in accordance with the (e.g. against the node indicated by the) popped test record entry.

In embodiments, as will be discussed in more detail below, the ray tracing circuit is operable to trace a group of plural rays together, and each ray of a group of rays being traced together is provided with a respective reserved storage region (stack) that the ray tracing circuit can use to store test record entries for the respective ray.

In the technology described herein, when it is determined that the ray tracing circuit may require additional storage space to store test record entries to trace a ray, e.g. and in embodiments when the reserved region (stack) for the ray becomes full, additional storage space is allocated for the ray tracing circuit to use to store (more) test record entries for the ray.

In embodiments, additional storage space is allocated from storage space that is shared between all of the rays of a group of plural rays being traced together, and thus that can be allocated for use to trace any ray of the group of plural rays.

Thus, in embodiments of the technology described herein, the storage includes, for each ray of a group of plural rays being traced together, an initial, “fixed” (“static”) allocation, storage region (e.g. stack) reserved for the ray tracing circuit to initially use to store test record entries to trace the respective ray. An additional, allocatable, shared storage region is then available for “dynamic” allocation for the ray tracing circuit to use to store (more) test record entries for any of the plural rays of the group.

As will be discussed in more detail below, the inventors have realised that for typically encountered ray tracing content, it is usually not necessary to provide each ray being traced with the maximum possible stack depth that could be required to trace a ray, but rather, a smaller stack depth is usually sufficient. For example, the inventors have calculated that ray tracing in Vulkan requires a maximum possible stack depth of 102 test record entries per ray, but typical content usually uses between 20 and 30 entries per ray.

The technology described herein exploits this by allowing dynamic allocation of additional stack depth. Thus, rather than providing a maximum possible required stack depth for each ray of a group of plural rays being traced together, each ray of the group can be provided with a smaller initial stack depth, but then be able to request additional stack depth from a shared allocatable storage region, should the need for a greater stack depth arise.

This can reduce or avoid the possibility of stack overflow, while reducing overall storage requirements for storing test record entries. The technology described herein can accordingly reduce area requirements for the local storage of a graphics processor that performs ray tracing. Moreover, as will be discussed in more detail below, this can be achieved without performance penalty.

It will be appreciated, therefore, that the technology described herein can provide an improved graphics processor and ray tracing method.

The graphics processor of the technology described herein is operable to perform ray tracing, e.g. and in embodiments, in order to generate a render output, such as a frame for display, e.g. that represent a view of a scene comprising one or more objects. The graphics processor may typically generate plural render outputs, e.g. a series of frames.

A render output will typically comprise an array of data elements (sampling points) (e.g. pixels), for each of which appropriate render output data (e.g. a set of colour value data) is generated by the graphics processor. A render output data may comprise colour data, for example, a set of red, green and blue, RGB values and a transparency (alpha, a) value.

The storage of the graphics processor can comprise any suitable storage. The storage should be, and in embodiments is, local to (e.g. on the same chip as) the graphics processor. The storage may comprise, e.g. and in embodiments, a set of registers and/or RAM, and e.g. form part of a cache system for the graphics processor. In embodiments, the storage has a fixed storage capacity.

The (ray tracing circuit of the) graphics processor may trace individual rays separately. In embodiments, the graphics processor is operable to trace a group of plural rays together. Thus, in embodiments, the ray tracing circuit traces a group of plural rays together, e.g. and in embodiments such that all of the rays in a group of rays traverse (visit) the nodes of the ray tracing acceleration data structure in the same node order. In embodiments, the arrangement in this regard is substantially as described in US 2022/0392147, the entire contents of which is incorporated herein by reference.

The graphics processor may carry out ray tracing graphics processing operations in any suitable and desired manner. In embodiments, the (e.g. ray tracing circuit of the) graphics processor comprises one or more programmable execution units (e.g. shader cores) operable to execute programs to perform graphics processing operations, and ray-tracing based rendering is triggered and performed by a programmable execution unit of the graphics processor executing a graphics processing (e.g. shader) program that causes the programmable execution unit to perform ray tracing rendering processes.

In embodiments, a program is executed by a group of plural execution threads together, e.g. and in embodiments, one execution thread for each ray in a group of rays being traced together. Thus, in embodiments, each ray is traced by a respective execution thread executing an appropriate (e.g. shader) program.

Typically in ray tracing, one or more rays are used to render a (each) sampling position in the render output, and for each ray being traced, it is determined which geometry that is defined for the render output is intersected by the ray (if any). Geometry determined to be intersected by a ray may then be further processed, e.g. in order to determine a colour for the sampling position in question.

The geometry to be processed to generate a render output may comprise any suitable and desired graphics processing geometry. In embodiments, the geometry comprises graphics primitives, in embodiments in the form of polygons, such as triangles, or bounding box primitives.

Determining which geometry (if any) is intersected by a ray can be performed in any suitable and desired manner. In general, there may be many millions of graphics primitives within a given scene, and millions of rays to be tested, such that it is not normally practical to test every ray against each and every graphics primitive. To speed up the ray tracing operation, embodiments of the technology described herein use a ray tracing acceleration data structure, such as a bounding volume hierarchy (BVH), that is representative of the distribution of the geometry in the (e.g.) scene that is to be rendered to determine the intersection of rays with geometry (e.g. objects) in the scene being rendered (and then render sampling positions in the output rendered frame representing the scene accordingly).

Ray tracing according to embodiments of the technology described herein therefore generally comprises (the ray tracing circuit) performing a traversal of the ray tracing acceleration data structure, which traversal involves testing rays for intersection with volumes represented by different nodes of the ray tracing acceleration data structure in order to determine which geometry may be intersected by which rays for a sampling position in the render output, and which geometry therefore needs to be further processed for the rays for the sampling position.

A ray tracing acceleration data structure can be arranged in any suitable and desired manner. In embodiments, the ray tracing acceleration data structure comprises a tree structure that is configured such that each end (e.g. leaf) node of the tree structure represents a set of geometry (e.g. primitives) defined within the respective volume that the end (e.g. leaf) node corresponds to, and with the other (non-leaf) nodes representing hierarchically-arranged larger volumes up to a root node at the top level of the tree structure that represents an overall volume for the render output (e.g. scene) in question that the tree structure corresponds to.

Each non-leaf node is therefore in embodiments a parent node for a respective set of plural child nodes with the parent node volume encompassing the volumes of its respective child nodes. In embodiments, each (non-leaf) node is associated with a respective plurality of child node volumes, each representing a (in embodiments non-overlapping) sub-volume within the overall volume represented by the (non-leaf) node in question.

Thus, in embodiments, at least one of the nodes of the ray tracing acceleration data structure is associated with a respective set of plural child nodes. In embodiments, there are multiple such nodes in the ray tracing acceleration data structure. These nodes may be referred to as “parent” nodes. They may also be referred to an “internal” or “non-leaf” nodes, for example, depending on the arrangement of the ray tracing acceleration data structure.

Thus, in embodiments, traversal of the ray tracing acceleration data structure comprises (the ray tracing circuit) proceeding down the “branches” of the tree structure and testing the rays against the child volumes associated with a node at a first level of the tree structure to thereby determine which child nodes in the next level of the tree structure should be tested, and so on, down to the level of the respective end (e.g. leaf) nodes at the end of the branches of the tree structure.

A ray tracing acceleration data structure could comprise, e.g. a single tree structure (e.g. BVH) representing the entirety of a scene being rendered. In embodiments, a ray tracing acceleration data structure comprises multiple “levels” of tree structures (e.g. BVHs).

For example, in embodiments, the ray tracing acceleration data structure comprises one or more “lowest level” tree structures (e.g. BVHs) (which may also be referred to as a “bottom level acceleration structure (BLAS)”), that each represent a respective instance or object within a scene to be rendered, and a “highest level” tree structure (e.g. BVH) (which may also be referred to as a “top level acceleration structure (TLAS)”) that refers to the one or more “lowest level” tree structures. In this case, each “lowest level” tree structure may comprise end (e.g. leaf) nodes that represent a set of geometry (e.g. primitives) associated with the respective instance or object, and the “highest level” tree structure may comprise end (e.g. leaf) nodes that point to, e.g. the root node of, one or more of the one or more “lowest level” tree structures.

In embodiments, each “lowest level” tree structure (e.g. BLAS) is defined in a space that is associated with the respective instance or object, e.g. a model space, whereas the “highest level” tree structure (e.g. TLAS) is defined in a space that is associated with the entire scene, e.g. a world space. In this case, each “highest level” tree structure end (e.g. leaf) node may include information indicative of an appropriate transformation between respective spaces. Correspondingly, traversal of the ray tracing acceleration data structure may comprise, when an end (e.g. leaf) node of the “highest level” tree structure is reached, applying a transformation indicated by the end (e.g. leaf) node, and then beginning traversal of the corresponding “lowest level” tree structure.

Once it has been determined by performing a traversal operation for a ray which end (e.g. leaf) nodes represent geometry that may be intersected by a ray, the actual geometry intersections for the ray for the geometry that occupies the volumes associated with the intersected end (e.g. leaf) nodes can be determined accordingly, e.g. by testing the ray for intersection with the individual units of geometry (e.g. primitives) defined for the render output (e.g. scene) that occupy the volumes associated with the end (e.g. leaf) nodes.

Thereafter, once the geometry intersections for the rays being used to render a sampling position have been determined, it can then be (and in embodiments is) determined what appearance the sampling position should have, and the sampling position rendered accordingly.

Thus, in embodiments, the (e.g. ray tracing circuit of the) graphics processor is operable to perform (the tests comprise) ray-volume intersection tests in which it is determined whether a ray intersects a volume represented by a node of the ray tracing acceleration data structure, and ray-geometry (e.g. primitive) intersection tests in which it is determined whether a ray intersects geometry (e.g. a primitive) occupying a volume represented by a node of the ray tracing acceleration data structure.

Ray-volume intersection tests and/or ray-geometry (e.g. primitive) intersection tests may be performed by a programmable execution unit of the graphics processor executing an appropriate program. In embodiments, the (e.g. ray tracing circuit of the) graphics processor comprises a ray-volume intersection testing circuit that is operable to perform ray-volume intersection tests, and that is in embodiments a (substantially) fixed function circuit. In embodiments, the (e.g. ray tracing circuit of the) graphics processor comprises a ray-geometry (e.g. primitive) intersection testing circuit that is operable to perform ray-geometry (e.g. primitive) intersection tests, and that is in embodiments a (substantially) fixed function circuit.

In embodiments, the execution of an appropriate program instruction triggers the programmable execution unit to message the ray-volume intersection testing circuit to cause the ray-volume intersection testing circuit to perform a ray-volume intersection test. In embodiments, the execution of an appropriate program instruction triggers the programmable execution unit to message the ray-geometry (e.g. primitive) intersection testing circuit to cause the ray-geometry (e.g. primitive) intersection testing circuit to perform a ray-geometry (e.g. primitive) intersection test.

In embodiments, the ray tracing acceleration data structure traversal is performed in a “leaves first” order. That is, in embodiments, a ray is tested against any leaf nodes that it has been determined that the ray may need to be tested against before any internal nodes that it has been determined that the ray may need to be tested against. In embodiments, the ray tracing acceleration data structure traversal is performed in an order substantially as described in United Kingdom Patent Applicant No. 2213007.4, the entire contents of which is incorporated herein by reference.

Other arrangements are possible.

In embodiments of the technology described herein, the ray tracing circuit makes use of a test (traversal) record to manage its traversal and testing operations. A separate test record may be maintained for each ray being traced, or a combined test record may be maintained, e.g. for a group of plural rays being traced together. In embodiments, a test record comprises a list of entries indicating which nodes have been determined to be intersected by a ray (and may need to be tested against the ray).

For example, and in embodiments, in order to track which nodes are intersected by a ray, and therefore need to be tested against the ray, whenever it is determined (by the ray tracing circuit) that a ray intersects a given node, an indication that the node (volume) is intersected is then pushed (added) to the test record for the traversal operation. The record of which nodes represent volumes that contain geometry that might be intersected by a ray can then be read (by the ray tracing circuit) to determine which nodes need to be tested, e.g. at the next level, and so on.

The ray tracing circuit uses the storage to store a test record for a (each) ray it is tracing. The ray tracing circuit is thus, in embodiments, operable to generate test (traversal) record entries, store the generated test record entries in the storage, read test record entries from the storage, and process test record entries read from the storage.

In embodiments, the record is stored in the form of a suitable stack, and is in embodiments managed using a “last-in-first-out” scheme, e.g. in the normal way for a stack. Thus, in embodiments, when the testing of a first parent node indicates that one or more of its child nodes are intersected, the child nodes are then pushed (added) to the stack, and nodes are popped out (removed) for testing accordingly.

Thus, in embodiments, the ray tracing circuit uses the storage to store a stack of test record entries. The ray tracing circuit may use registers (of the storage) to store the top entry of the stack, and use RAM (of the storage) to store other entries of the stack.

In embodiments, the storage includes an initial storage region reserved for the ray tracing circuit to initially use to store the test record for a ray. In embodiments, the reserved region for a ray is a stack that an execution thread that is executing a program to trace the ray has access to. In embodiments, there is a respective initial region (e.g. stack) of the storage for each ray of a group of rays being traced together. Thus, in embodiments, there are plural (e.g. private) reserved regions of the storage: one for each ray of a group of plural rays being traced together (and correspondingly one for each thread of a group of threads executing together).

Thus, in embodiments, the storage includes an initial storage region reserved for the ray tracing circuit to initially use to store test record entries to trace a (each) ray. In embodiments, it is then determined whether the ray tracing circuit may require additional storage space to store test record entries to trace a ray by determining whether the ray tracing circuit may require that more test record entries are stored to trace the ray than can be stored in the (respective) initial storage region for the ray. In embodiments, it is determined that the ray tracing circuit may require additional storage space to store test record entries to trace a ray when it is determined that the ray tracing circuit may require that more test record entries are stored to trace the ray than can be stored in the (respective) initial storage region for the ray.

An initial storage region can be any suitable and desired size. There may be initial storage regions of different sizes, but in embodiments initial storage regions are all the same size. In embodiments, a (each) initial storage region (e.g. stack) for a ray comprises less storage than would be required to store a maximum possible number of test record entries that could need to be stored to trace the ray. For example, as mentioned above, the inventors have calculated that the maximum possible number of test record entries that could need to be stored to trace a ray (the maximum possible “stack depth”) in Vulkan is 102. A (each) initial storage region for a ray may thus comprise less storage than required to store e.g. 102 test record entries. Other numbers would be possible.

In embodiments, a (each) initial storage region (e.g. stack) for a ray comprises sufficient storage to store enough test record entries to facilitate the entire tracing of the ray under “normal” expected circumstances. For example, as also mentioned above, the inventors have found that about 20-30 test record entries are typically required to trace a ray in Vulkan under normal circumstances. A (each) initial storage region for a ray may thus comprise sufficient storage to store greater than or equal to e.g. 20 to 30 test record entries. Again, other numbers are possible. This can allow typical ray tracing content to be rendered without usually having to request additional storage.

Thus, in embodiments, an (each) initial storage region (e.g. stack) for a ray comprises enough storage space to store a particular, in embodiments selected, in embodiments predetermined, (maximum) number of test record entries for the ray, such as, and in embodiments, 32 test record entries. Other numbers, such as 64, are possible.

In embodiments, the storage (also) includes an (additional) allocatable storage region that is reserved for dynamic allocation (by the allocation circuit). In embodiments, the arrangement is such that (when allocated) the ray tracing circuit can use an initial storage region and the allocatable storage region together (e.g. as a single stack) to store test record entries to trace a ray.

In embodiments, the allocatable storage region is “shared” between all of the rays of a group of plural rays that are being traced together. Thus, in embodiments, there is only one allocatable storage region (per group of plural rays being traced together).

Thus, in embodiments, the storage includes an allocatable storage region reserved for dynamic allocation (by the allocation circuit) for storing (more) test record entries to trace any ray of a group of plural rays being traced together. In embodiments, when it is determined that the ray tracing circuit may require additional storage space to store test record entries to trace a ray, additional storage space is allocated from the allocatable storage region for the ray tracing circuit to use to store test record entries to trace the ray.

Thus, in embodiments, the storage includes: for each ray of a group of plural rays being traced together, a respective initial storage region (e.g. “fixed”/“static” allocation) for the ray tracing circuit to initially use to store test record entries to trace the respective ray; and a further (“shared”) allocatable storage region for the ray tracing circuit to use to store (more) test record entries to trace any ray of the group of plural rays.

Thus, according to an embodiment of the technology described herein, there is provided a graphics processor that is operable to perform ray tracing, wherein the graphics processor comprises:
storage;
a ray tracing circuit operable to trace a group of plural rays together by performing tests to determine whether the rays intersect geometry representing a scene to be rendered, wherein the ray tracing circuit is operable to use the storage to store test record entries for rays being traced, wherein each test record entry indicates a test that may need to be performed to trace a ray (e.g. by indicating a node of the ray tracing acceleration data structure that a ray may need to be tested against); and
an allocation circuit operable to:
determine whether the ray tracing circuit may require additional storage space to store test record entries to trace a ray of a group of plural rays being traced together; and
when it is determined that the ray tracing circuit may require additional storage space to store test record entries to trace a ray of a group of plural rays being traced together:
   allocate storage space from an allocatable storage region of the storage that is reserved for the allocation circuit to allocate to store test record entries to trace any ray of the group of plural rays.

According to an embodiment of the technology described herein, there is provided a method of operating a graphics processor that is operable to perform ray tracing, wherein the graphics processor comprises:
storage; and
a ray tracing circuit operable to trace a group of plural rays together by performing tests to determine whether the rays intersect geometry representing a scene to be rendered, wherein the ray tracing circuit is operable to use the storage to store test record entries for rays being traced, wherein each test record entry indicates a test that may need to be performed to trace a ray (e.g. by indicating a node of the ray tracing acceleration data structure that a ray may need to be tested against);
the method comprising:
providing an allocatable storage region of the storage that is reserved for allocation to store test record entries to trace any ray of a group of plural rays being traced together;
determining whether the ray tracing circuit may require additional storage space to store test record entries to trace a ray of the group of plural rays being traced together; and
when it is determined that the ray tracing circuit may require additional storage space to store test record entries to trace a ray of the group of plural rays being traced together:
   allocate additional storage space from the allocatable storage region for the ray tracing circuit to use to store test record entries to trace the ray.

An (the) allocatable storage region can be any suitable and desired size. In embodiments, the arrangement is such that a (each) ray is initially provided with sufficient storage to make progress under “normal” circumstances, and the allocatable storage region has sufficient additional space to ensure that progress can be made by at least one ray (of a group of rays being traced together) under “extreme” circumstances.

Thus, in embodiments, the allocatable storage region comprises sufficient storage to store, in combination with an initial storage region, the maximum possible number of test record entries that could need to be stored to trace the ray. Thus, for example and in embodiments, in the case of a maximum of 102 test record entries, and an initial storage region being able to store 32 test record entries, the allocatable storage region may comprise sufficient storage to store 70 test record entries. Other numbers are possible.

In other embodiments, rather than a (each) ray being initially provided with a (respective) initial (“fixed”/“static”) storage region, only dynamically allocatable storage space is available. Thus, in embodiments, the storage includes (only) an allocatable storage region reserved for dynamic allocation (by the allocation circuit) for storing test record entries to trace a (any) ray (of a group of plural rays being traced together). In this case, the allocatable storage region should, and in embodiments does, have sufficient space to ensure that progress can be made by at least one ray (of a group of plural rays being traced together) in any circumstances.

The allocatable storage region can be allocated for use (by the allocation circuit) in any suitable and desired manner. In embodiments, the allocatable storage region is allocated (by the allocation circuit) in response to a suitable request, e.g. from a programmable execution unit of the graphics processor.

Allocating additional storage space from the allocatable storage region may comprise allocating the allocatable storage region as a whole. Thus, the allocatable storage region may only be allocated to (only) one ray of a group of rays (or thread of a group of threads) at a time. In this case, in embodiments, a ray that requires additional storage may need to wait for another ray to finish using the allocatable storage region before it can proceed.

Alternatively, different parts of the allocatable storage region may be allocated differently. For example, different parts of the allocatable storage region may be allocated to different rays of a group of rays (different threads of a group of threads), e.g. at the same time.

The allocatable storage region may, for example and in embodiments, be dynamically allocable in steps corresponding to a particular, in embodiments selected, in embodiments predetermined, number of test record entries, such as 1, 2, 4, 8, 16, 32, 64, or another number.

In the technology described herein, “dynamic” allocation (by the allocation circuit) is triggered in response to it being determined that the ray tracing circuit may require additional storage space to store test record entries to trace a ray. The “dynamic” allocation may be triggered in response to it being determined that the ray tracing circuit definitely does require additional storage space, or in response to it being determined that it has become possible that the ray tracing circuit may require additional storage space.

In embodiments, it is determined whether a maximum number of test record entries that can (currently) be stored for a ray are (currently) being stored. For example, it may be determined whether the initial storage region (stack) for the ray is full, i.e. whether the initial storage region (stack) for the ray is storing the maximum number (e.g. 32) of test record entries. It may then be determined that the ray tracing circuit may require additional storage space to store test record entries to trace a ray when it is determined that a maximum number of test record entries that can (currently) be stored for the ray are (currently) being stored (e.g. when it is determined that the initial storage region (stack) for the ray is full).

In other embodiments, (when it is determined that a maximum number of test record entries that can (currently) be stored for the ray are (currently) being stored) it is determined whether a next operation (test) to be performed by the ray tracing circuit to trace the ray may require that another test record entry is stored for the ray, and it is determined that the ray tracing circuit may require additional storage space to store test record entries to trace a ray when it is determined that a next operation (test) to be performed by the ray tracing circuit to trace the ray may require that another test record entry is stored for the ray.

It may be determined whether a next operation (test) to be performed by the ray tracing circuit to trace the ray may require that another test record entry is stored in any suitable and desired manner. In embodiments, it is determined (by the allocation circuit) whether the next operation (test) is a ray-volume intersection test, and it is determined that a next operation (test) to be performed by the ray tracing circuit to trace the ray may require that another test record entry is stored in the storage when it is determined that the next operation (test) is a ray-volume intersection test.

Correspondingly, in embodiments it is determined (by the allocation circuit) that a next operation (test) to be performed by the ray tracing circuit to trace the ray will not require that another test record entry is stored when it is determined that the next operation (test) is a ray-geometry (e.g. primitive) intersection test.

In embodiments, as well as (the allocation circuit) allocating additional storage space when needed, additional storage space can be released (deallocated) when it is no longer needed. Thus, in embodiments it is determined (by the allocation circuit) whether the ray tracing circuit requires that fewer test record entries are stored to trace a ray than can (currently) be stored for the ray, and when it is determined that the ray tracing circuit requires that fewer test record entries are stored to trace a ray than can (currently) be stored for the ray, storage space that the ray tracing circuit was using to trace the ray is deallocated (released) (by the allocation circuit).

Storage space can be deallocated (released) in any suitable and desired manner. Storage space may, for example, be deallocatable in steps, e.g. substantially as described above for the allocation process. In embodiments, deallocating storage space comprises deallocating the allocatable storage region as a whole.

In embodiments, it is determined (by the allocation circuit) whether the ray tracing circuit requires that the same or fewer test record entries are stored to trace a ray than can be stored in the initial storage region for the ray, and when it is determined that the ray tracing circuit requires that the same or fewer test record entries are stored to trace a ray than can be stored in the initial storage region for the ray, the allocatable storage region is deallocated. The allocatable storage region may then be available for (re-) allocation (e.g. to a ray of the same group of rays).

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The processor may also comprise, and/or be in communication with, one or more memories and/or memory devices that store the data described herein, and/or store software (e.g. (shader) program) for performing the processes described herein. The processor may also be in communication with a host microprocessor, and/or with a display for displaying images based on data generated by the processor.

The technology described herein can be used for all forms of input and/or output that a graphics processor may use or generate. For example, the graphics processor may execute a graphics processing pipeline that generates frames for display, render-to-texture outputs, etc., The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the data processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc . . . .

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

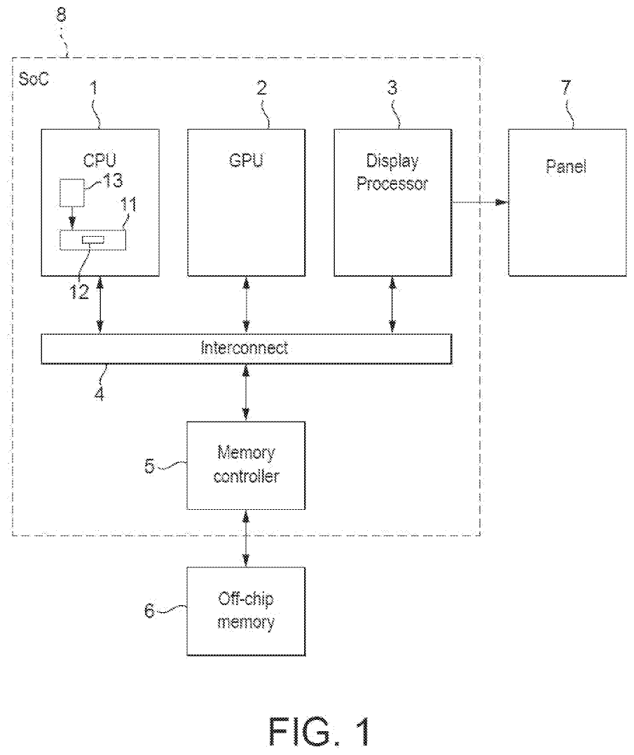

The present embodiments relate to the operation of a graphics processor, e.g. in a graphics processing system as illustrated in FIG. 1, when performing rendering of a scene to be displayed using a ray tracing based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of objects within the scene which a ray passing through the sampling position intersects.

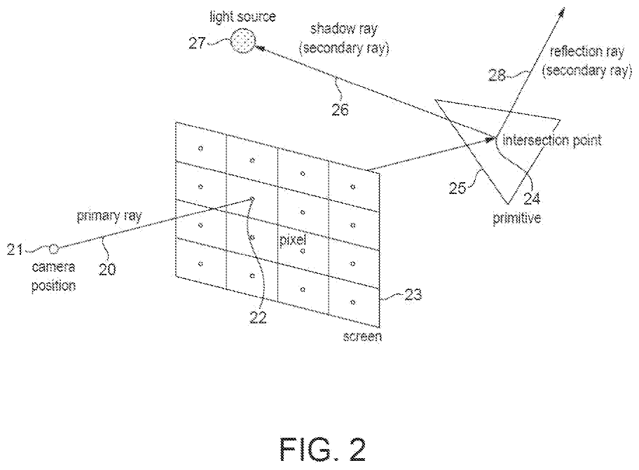

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object 25, e.g. a primitive (which primitives in the present embodiments are in the form of triangles, but may also comprise other suitable geometric shapes), in the scene is identified. This first intersection will be with the object in the scene closest to the sampling position.

A secondary ray in the form of shadow ray 26 may be cast from the first intersection point 24 to a light source 27. Depending upon the material of the surface of the object 25, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

In order to facilitate such ray tracing processing, in the present embodiments acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

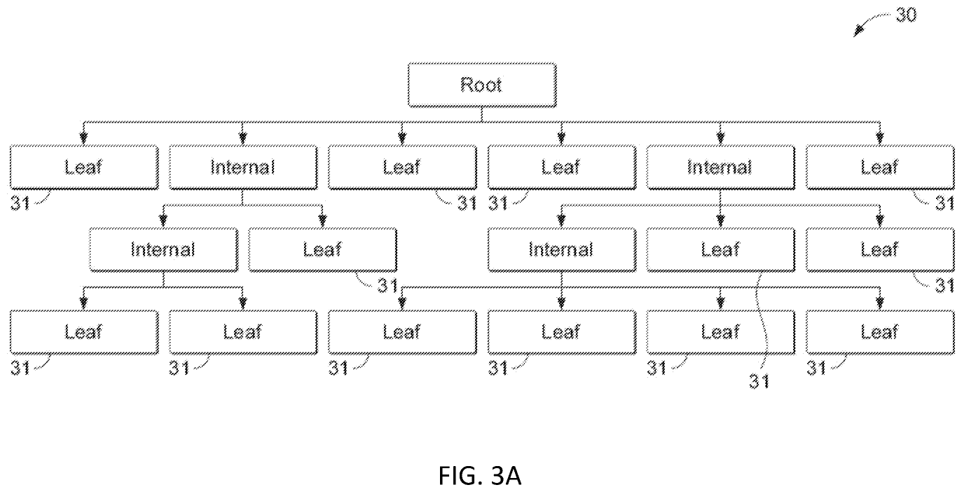

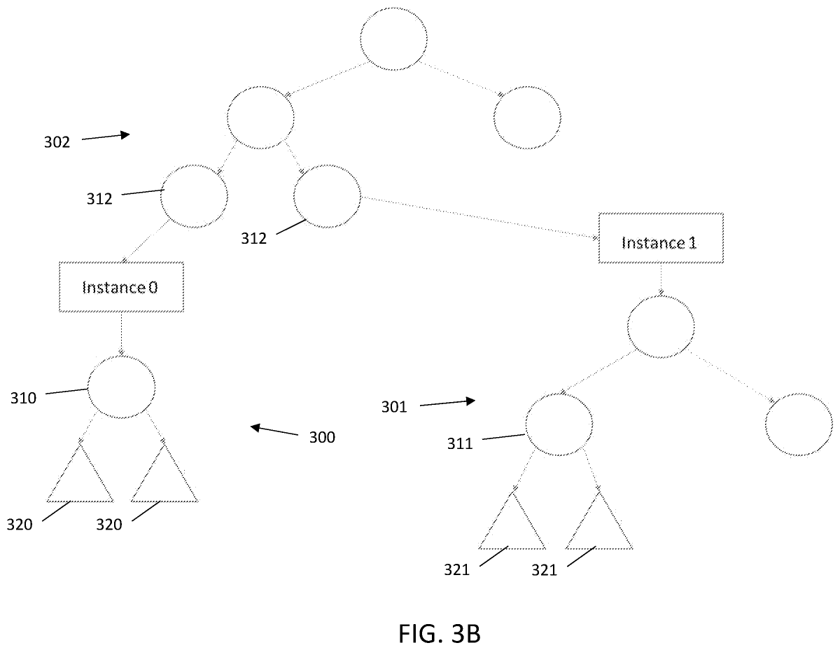

FIG. 3A shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

In the present embodiments, a two-level ray tracing acceleration data structure is used. FIG. 3B shows an exemplary two-level ray tracing acceleration data structure in which each instance or object is associated with a respective bottom-level acceleration structure (BLAS) 300, 301, which in the present embodiments is in the form of a respective BVH tree that stores geometry in model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in world space and is in the form of a BVH tree having leaf nodes 312 that each point to one or more of the bottom-level acceleration structures (BLAS) 300, 301.

Other forms of ray tracing acceleration data structure would be possible.

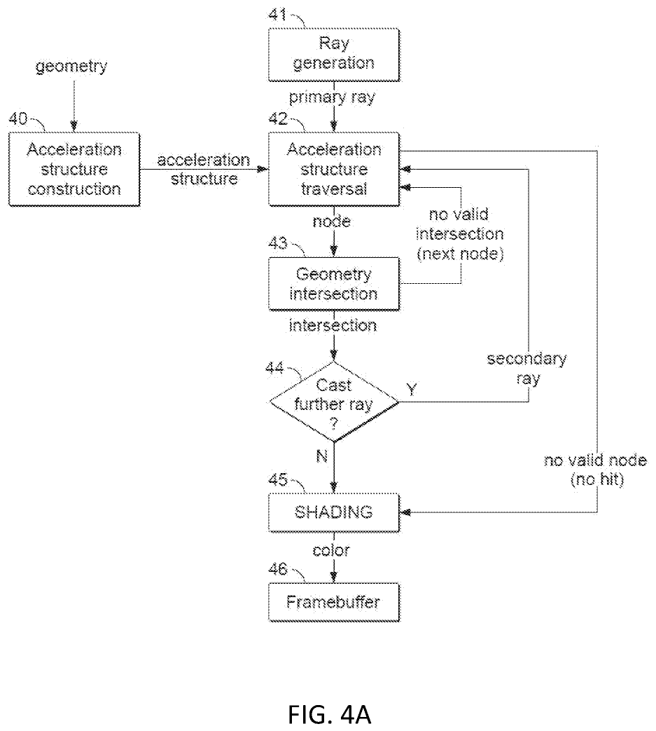

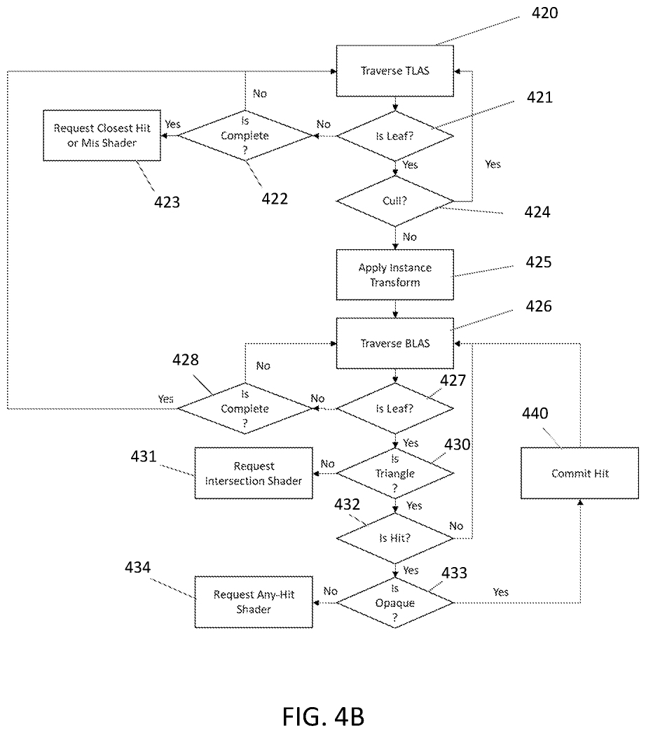

FIG. 4A is a flow chart showing an overall ray tracing process that may be performed on and by the graphics processor 2.

First, the geometry of the scene is analysed and used to obtain an acceleration data structure (step 40), for example in the form of one or more BVH tree structures, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified.

When geometry that the ray intersects is identified, it is then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 4A, one or more secondary rays may be generated emanating from the intersection point (e.g. a shadow ray(s), a refraction ray(s) and/or a reflection ray(s), etc.). Steps 42, 43 and 44 are then performed in relation to each secondary ray.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc., The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements would be possible.

This process is performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

FIG. 4B is a flow chart showing in more detail acceleration structure traversal in the case of a two-level acceleration data structure, e.g. as described above with reference to FIG. 3B. As shown in FIG. 4B, in this case, acceleration structure traversal begins with TLAS traversal (step 420), and TLAS traversal continues in search of a TLAS leaf node (steps 421, 422). If no TLAS leaf node can be identified, a “default” shading operation (“miss shader”) may be performed (step 423), e.g. as described above.

When (at step 421) a TLAS leaf node is identified, it is determined whether that leaf node can be culled from further processing (step 424). If it can be culled from further processing, the process returns to TLAS traversal (step 420).

If the TLAS leaf node cannot be culled from further processing, instance transform information associated with the leaf node is used to transform the ray to the appropriate space for BLAS traversal (step 425). BLAS traversal then begins (step 426), and continues in search of a BLAS leaf node (steps 427, 428). If no BLAS leaf node can be identified, the process may return to TLAS traversal (step 420).

In the present embodiments, geometry associated with a BLAS leaf node can be in the form of a set of triangle primitives or an axis aligned bounding box (AABB) primitive. When (at step 427) a BLAS leaf node is identified, it is determined whether geometry associated with the leaf node is in the form of a set of triangle primitives or an axis aligned bounding box (AABB) primitive (step 430). As shown in FIG. 4B, when an axis aligned bounding box (AABB) primitive is encountered, execution of a shader program (“intersection shader”) that defines a procedural object encompassed by the axis aligned bounding box (AABB) is triggered (step 431) to determine whether a ray intersects the procedural object defined by the shader program. On the other hand, when a set of triangle primitives is encountered, determining whether a ray intersects any of the triangle primitives is performed by fixed function circuitry (step 432) (as will be discussed further below). Other arrangements would be possible.

If no (valid) triangle primitives which the ray intersects can be identified in the node, the process returns to BLAS traversal (step 426). If a ray is found to intersect a triangle primitive, it is determined whether or not the triangle primitive is opaque (step 433). In the case of the triangle primitive being found to be non-opaque, execution of an appropriate shader program (“any-hit shader”) may be triggered (step 434). Otherwise, in the case of the triangle primitive being found to be opaque, the intersection can be committed without executing a shader program (step 440). Traversal for one or more secondary rays may be triggered, as appropriate, e.g. as discussed above.

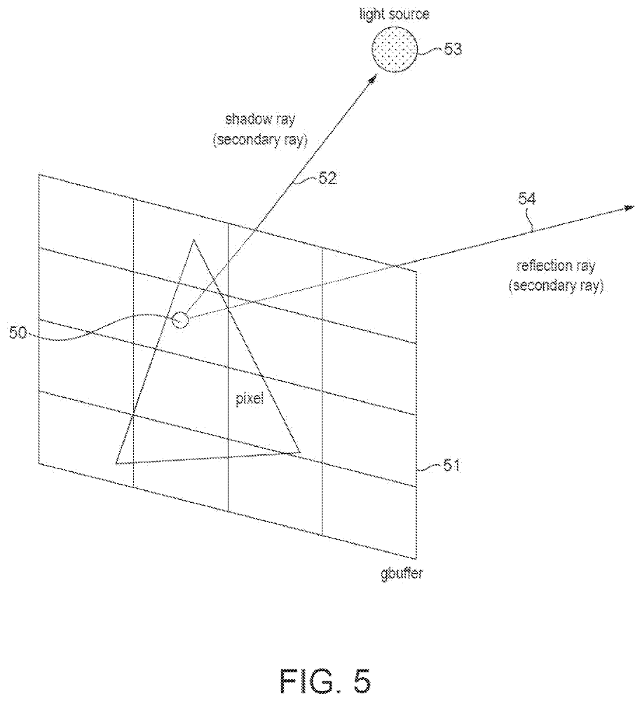

FIG. 5 shows an alternative ray tracing process which may be used in embodiments of the technology described herein, in which only some of the steps of the full ray tracing process described above are performed. Such an alternative ray tracing process may be referred to as a “hybrid” ray tracing process.

In this process, as shown in FIG. 5, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 4A, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 4. Thus, steps 42, 43 and 44 will be performed in the same manner as previously described in relation to the full ray tracing process for any secondary rays.

The colour determined for a sampling position will be written to the frame buffer in the same manner as step 46 of FIG. 4A, based on the shading colour determined for the sampling position based on the first intersection point (as obtained from the G-buffer), and, where applicable, the intersections of any secondary rays with objects in the scene, determined using ray tracing.

The present embodiments relate in particular to the operation of a graphics processor when performing ray tracing-based rendering, e.g. as described above, and in particular to the ray tracing acceleration data structure traversal performed as part of the ray tracing operation.

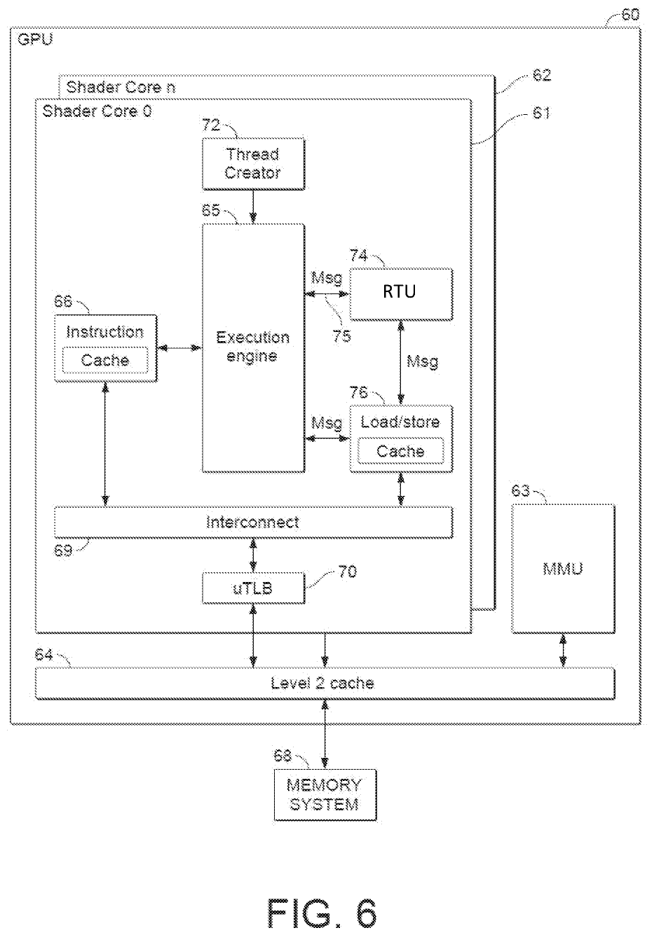

FIG. 6 shows schematically the relevant elements and components of a graphics processor (GPU) 2, 60 of the present embodiments.

As shown in FIG. 6, the GPU 60 includes one or more shader (processing) cores 61, 62 together with a memory management unit 63 and a level 2 cache 64 which is operable to communicate with an off-chip memory system 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc . . . . The shader cores will process each “item” by means of one or more execution threads which will execute the instructions of the shader program(s) in question for the “item” in question. Typically, there will be multiple execution threads each executing at the same time (in parallel).

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered).

Accordingly, as shown in FIG. 6, the shader core 61 further comprises a thread creator (generator) 72 operable to generate execution threads for execution by the programmable execution unit 65.

In the present embodiments, the ray tracing traversal operation is performed for a group of plural rays together, e.g. substantially as described in US 2022/0392147. This allows processing resources for groups of rays to be shared.

In particular, a ray tracing traversal program is executed by a group (“warp”) of plural execution threads, with each ray in the group of plural rays being processed by a corresponding execution thread in a group of plural execution threads that are executing the program at the same time. The thread creator (generator) 72 may thus generate groups (“warps”) of plural execution threads, and the programmable execution unit 65 may execute shader programs for a group (“warp”) of plural execution threads together, e.g. in lockstep, e.g., one instruction at a time.

In the present embodiments, each group of rays includes 32 rays (and correspondingly each group (“warp”) of execution threads includes 32 threads), but other numbers are possible.

As shown in FIG. 6, the shader core 61 in this embodiment also includes a ray tracing circuit (unit) (“RTU”) 74, which is in communication with the programmable execution unit 65, and which is operable to perform the required ray-volume testing during the ray tracing acceleration data structure traversals (e.g. the operation of step 42 of FIG. 4A) for rays being processed as part of a ray tracing-based rendering process, in response to messages 75 received from the programmable execution unit 65.

In the present embodiments the RTU 74 is also operable to perform the required ray-primitive testing (e.g. the operation of step 43 of FIG. 4A). The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-primitive intersection testing during a traversal of a ray tracing acceleration data structure to determine geometry for a scene to be rendered that may be (and is) intersected by a ray being used for a ray tracing operation. However, some amount of configurability may be provided. Other arrangements would be possible. For example, ray-volume and/or ray-primitive intersection testing may be performed by the programmable execution unit 65 (e.g. in software).

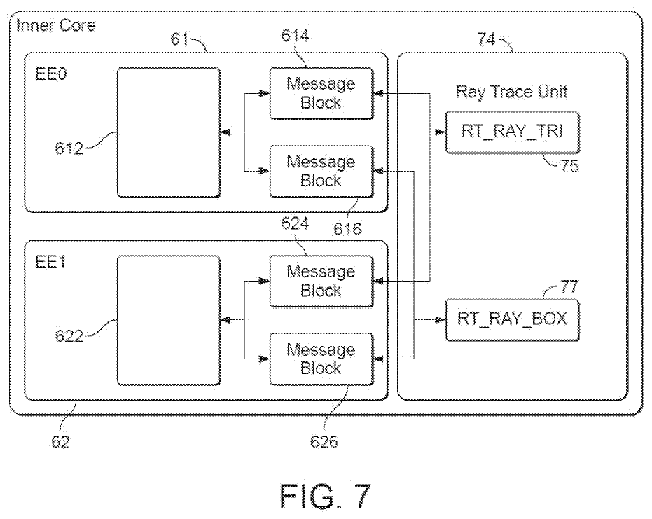

FIG. 7 shows in more detail the communication between the RTU 74 and the shader cores 61, 62, in the present embodiments. As shown in FIG. 7, in the present embodiments, the RTU 74 includes respective hardware circuits for performing the ray-volume testing (RT_RAY_BOX) 77 and for performing the ray-primitive testing (RT_RAY_TRI) 75. The shader cores 61, 62 thus contain appropriate message blocks 614, 616, 624, 626 for messaging the respective ray-volume testing circuit 77 and ray-primitive testing circuit 75 accordingly when it is desired to perform intersection testing during a traversal operation.

In the present embodiments, execution of an appropriate ray-volume testing instruction (′RT_RAY_BOX′) included in a shader program triggers the execution unit 65 to message the ray-volume intersection testing circuit 77 of the RTU 74 to perform the desired ray-volume testing. Similarly, execution of an appropriate instruction (′RT_RAY_TRI′) included in a shader program triggers the execution unit to message the ray-primitive intersection testing circuit 75 of the RTU 74 to perform the desired ray-primitive testing.

As shown in FIG. 7, the message blocks communicate with respective local storage 612, 622 of the shader cores 61, 62 so that the result of the intersection testing can be stored locally.

In particular, in the present embodiments the traversal operation is managed for a group of plural rays together using a traversal stack that is maintained in the local storage 612, 622. The local storage 612, 622 can comprise any suitable and desired type of storage, such as registers, RAM, etc.,

A traversal stack includes stack entries that each indicate a node to be visited and tested, with the top entry in the stack indicating the next node to be visited and tested for a ray. The top entry in the stack is accordingly popped to determine the next node to visit and test, and when it is determined that a new node should be visited and tested, a corresponding stack entry is pushed to the stack.

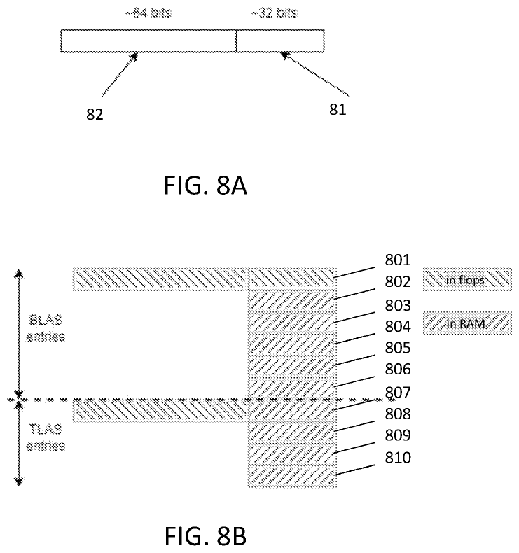

FIG. 8A illustrates an exemplary stack entry, according to embodiments. As shown in FIG. 8A, in the present embodiments, each stack entry includes node information 81 that includes information indicating a volume associated with a node to be tested and any child nodes that are associated with the node. A stack entry that relates to a leaf node further includes leaf information 82 that may indicate geometry represented by the leaf node in question (e.g. in the case of a BLAS leaf node) or references to one or more other (e.g. BLAS) acceleration structures together with shading and transformation information (e.g. in the case of a TLAS leaf node).

As shown in FIG. 8A, in the present embodiments the node information 81 comprises 32 bits, and the leaf information 82 comprises 64 bits. A leaf node stack entry thus comprises 96 bits, whereas an internal node stack entry comprises only 32 bits. Other arrangements are possible.

FIG. 8B illustrates an exemplary stack of entries to be processed by a shader core 61, 62. As shown in FIG. 8B, in this example, the stack includes six stack entries 801-806 for BLAS nodes at the top of the stack, and four stack entries 807-810 for TLAS nodes at the bottom of the stack.

In the present embodiments, the acceleration structure traversal order is configured such that when there is a choice between visiting a leaf node or an internal node of an acceleration structure next, the leaf node is visited next. To facilitate this, as illustrated in FIG. 8B, in the present embodiments a BLAS leaf node entry 801 (when present in the stack) is maintained as the topmost BLAS stack entry, and a TLAS leaf node entry 807 (when present in the stack) is maintained as the topmost TLAS stack entry. This moreover means that there can be a maximum of one BLAS leaf node stack entry and one TLAS leaf node stack entry present in a stack at any one time. Thus, and as illustrated in FIG. 8B, in this example there is only one BLAS leaf node entry 801, and only one TLAS leaf node entry 807.

In the present embodiments, the local storage 612, 622 of each shader core is provided with registers (flip-flops) that can store two larger (e.g. 96 bit), leaf node entries for each ray it is tracing. The topmost BLAS stack entry and the topmost TLAS stack entry are then stored in these registers. Since the top entry in the stack is accessed most frequently, this can facilitate fast stack access.

The other (less frequently accessed) entries are then stored in L1 cache (RAM). As each of these other entries can only be a smaller (e.g. 32 bit), internal node stack entry, this can minimise RAM requirements. Other arrangements are possible.

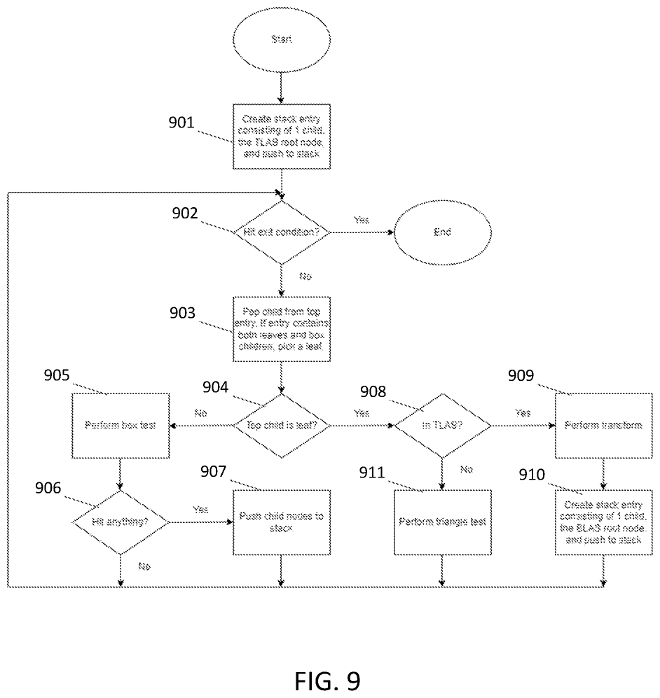

FIG. 9 is a flowchart showing the operation of a shader core 61, 62 of the graphics processor 2, 60 when performing a ray tracing-based rendering process in embodiments of the technology described herein. FIG. 9 shows the operation in respect of a given ray, and this operation will be performed for each ray being traced.

As shown in FIG. 9, the process begins with a first entry being pushed to the stack corresponding to the TLAS root node (step 901). There is then a check to determine whether tracing for the current ray is complete (step 902), and if not, the process continues with the top entry in the stack being popped (step 903) for processing.

As the TLAS root node should be an internal node (i.e. not a leaf node) (at step 904), it is subjected to a ray-volume intersection test (at step 905), and for any child nodes determined to be intersected (at step 906), a corresponding stack entry is pushed to the stack (at step 907). The process then returns to step 902 to determine whether tracing for the current ray is complete, and if not, the process continues with the top entry in the stack being popped (step 903) for processing.

As shown in FIG. 9, when a TLAS leaf node is reached (step 908), transformation information associated with the leaf node is used to transform the ray (step 909), and a stack entry corresponding to a BLAS root node is pushed to the stack (step 910). The process then returns to step 902 to determine whether tracing for the current ray is complete, and if not, the process continues with the top entry in the stack being popped (step 903) for processing.

As a BLAS root node should be an internal node (i.e. not a leaf node) (at step 904), it is subjected to a ray-volume intersection test (at step 905), and for any child nodes determined to be intersected (at step 906), a corresponding stack entry is pushed to the stack (step 907). The process then returns to step 902 to determine whether tracing for the current ray is complete, and if not, the process continues with the top entry in the stack being popped (step 903) for processing.

As shown in FIG. 9, when a BLAS leaf node is reached (step 908), the geometry associated with the leaf node is subjected to a ray-primitive intersection test (at step 911). The process then returns to step 902 to determine whether tracing for the current ray is complete, and if not, the process continues with the top entry in the stack being popped (step 903) for processing.

A stack overflow can occur where a stack does not have enough space to accept another entry. The inventors have realised that ray tracing APIs can implicitly impose a maximum possible number of stack entries per ray. For example, in the case of ray tracing in Vulkan, the inventors have calculated a maximum possible stack depth of 102 entries per ray. Accordingly, it would be possible to avoid the possibility of stack overflow by providing sufficient local storage 612, 622 to store the API implied maximum possible number of stack entries per ray (e.g. 102 stack entries per ray in the case of Vulkan).

The inventors have found, however, that typical content may actually use a maximum stack depth of between 20 and 30 stack entries per ray, and thus there can be a relatively large mismatch between the API implied maximum stack depth and the stack depth that is typically required in practical applications.

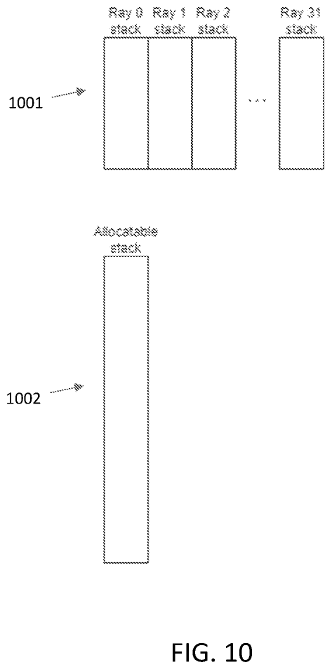

FIG. 10 shows a memory layout for a group (warp) of 32 rays, according to embodiments of the technology described herein. As shown in FIG. 10, in these embodiments, each ray in a group of 32 rays is provided with a respective “fixed” (“static”) initial allocation 1001 of local storage 612, 622 that is large enough to store a maximum of 32 stack entries. Each ray is accordingly initially provided with sufficient stack depth to handle typical ray tracing operations.

As illustrated in FIG. 10, the group of rays as a whole is then provided with a further allocatable region 1002 of the local storage 612, 622 that is large enough to store a maximum of 70 stack entries.

Any ray in the group that needs to store more stack entries than can be stored in its initial allocation 1001 of the local storage 612, 622 can then request dynamic allocation of the allocatable region 1002 of the local storage 612, 622. In this way, it is possible for a ray in the group to reach the API implied maximum stack depth of 32+70=102 stack entries, thus avoiding the possibility of stack overflow.

It will be appreciated that in this embodiment, rather than the local storage 612, 622 requiring storage sufficient to store the API implied maximum of 32×102=3264 stack entries per ray group, the local storage 612, 622 only requires sufficient storage to store (32×32)+70=1094 stack entries per ray group.

Embodiments of the technology described herein can accordingly minimise local storage (and thus area) requirements, while avoiding the possibility of stack overflow. Moreover, this can typically be achieved without significant performance penalty, since each ray is initially provided with sufficient stack depth to handle typical ray tracing operations, such that a dynamic allocation operation may only be typically rarely triggered.

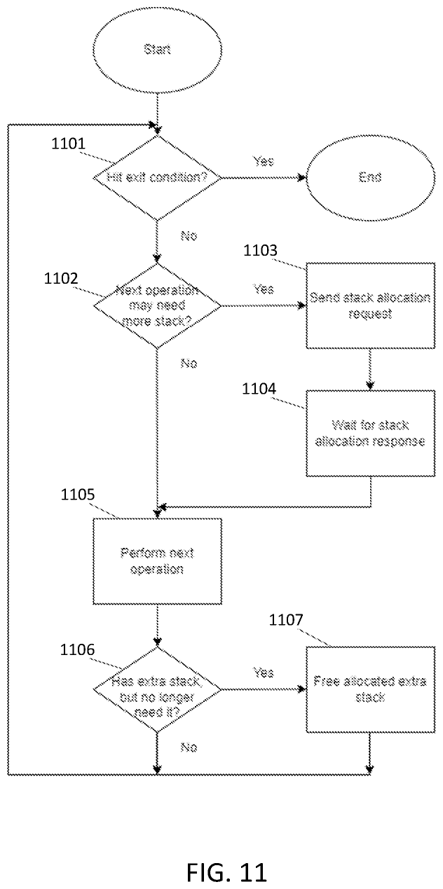

FIG. 11 shows a stack allocation process according to embodiments of the technology described herein. As shown in FIG. 11, it is determined (at step 1102) whether a next operation for a ray may need to store more stack entries than can be stored in the traversal stack being maintained for the ray. If it is determined (at step 1102) that a next operation for a ray may need to store more stack entries than can be stored in the traversal stack being maintained for the ray, a request is sent (at step 1103) for the dynamic allocation of the allocatable memory region 1002.

The process then waits (at step 1104) for the dynamic allocation to succeed before the next operation is performed for the ray (at step 1105). The allocatable memory region 1002 thus becomes part of the memory available to store stack entries for the ray, such that stack entries for the ray can then be stored in the respective initial allocation 1001 together with the allocatable memory region 1002.

The request for dynamic allocation may be triggered whenever the top active entry of a stack for a ray corresponds to the last (32^{nd}) entry of the initial allocation 1001. Alternatively, the request for dynamic allocation may be triggered in response to determining that a next operation may require that an additional (33^{rd}) stack entry is stored.

For example, when the top active entry of a stack for a ray corresponds the last (32^{nd}) entry of the initial allocation 1001, it may be determined whether the next operation is a ray-primitive intersection test or a ray-volume intersection test, and a request for dynamic allocation may be triggered in response to determining that the next operation is a ray-volume intersection test, e.g. because the results of a ray-volume intersection test can trigger a new stack entry being pushed to the stack. On the other hand, a request for dynamic allocation may not be triggered in response to determining that the next operation is a ray-primitive intersection test, since the results of a ray-primitive intersection test cannot trigger a new stack entry being pushed to the stack.

As shown in FIG. 11, it is determined (at step 1106) whether the allocatable region 1002 allocated to the ray is no longer required. If it is determined (at step 1106) that the allocatable region 1002 allocated to the ray is no longer required, the allocatable region 1002 is released (at step 1107) so that it is available again for dynamic allocation.

The release of the allocatable region 1002 may be triggered whenever the top active entry of a stack for a ray returns to the last (32^{nd}) entry of the initial allocation 1001, or another entry of the initial allocation 1001, such as the penultimate (31^{st}) entry.

It will be appreciated that in embodiments, the allocatable region 1002 can store sufficient stack entries for at least one ray of a group of rays to be able to reach the API implied maximum stack depth (e.g. 102 stack entries in the present embodiments). This can avoid the possibility of a deadlock.

In the present embodiment, the allocatable region 1002 can only be allocated to one ray at a time as a whole. A ray in a group that requires additional stack may thus need to wait until another ray in the group has released the allocatable region 1002. However, in other embodiments, the allocatable region 1002 may be allocated in smaller chunks and/or to different rays in a group. The allocatable region 1002 could, for example, be allocatable in steps of 1, 2, 4, 8, 16, 32, 64, or other numbers, of stack entries.

Although in the above embodiment, there is an initial allocation 1001 that can store 32 stack entries per ray in a group of 32 rays, an allocatable region 1002 that can store 70 stack entries for the group, and thus a maximum stack depth of 102 for a ray, it will be appreciated that other numbers are possible. For example, there may be more or less than 32 rays in a group, such as 1, 2, 4, 8, 16 or 64 rays per group. Similarly, the allocatable region 1002 may be able to store more or less than 70 stack entries. Correspondingly, the maximum stack depth may be more or less than 102. Similarly, each ray in a group could be initially allocated more or less than 32 stack entries' worth of storage, such as 2, 4, 8, 16 or 64 stack entries.

In some embodiments, each ray in a group is initially provided with no initial allocation, and storage for all stack entries is provided by dynamic allocation from an allocatable pool 1002.

It will be appreciated from the above that the technology described herein, in its embodiments at least, provides arrangements in which the storage (stack) requirements for ray tracing test record entries can be reduced. This is achieved, in the embodiments of the technology described herein at least, by providing a shared allocatable storage region that can be dynamically allocated to different rays when additional storage for ray tracing test record entries is required.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A graphics processor that is operable to perform ray tracing, wherein the graphics processor comprises:
storage;
a ray tracing circuit operable to trace rays by performing tests to determine whether the rays intersect geometry representing a scene to be rendered, wherein the ray tracing circuit is operable to use the storage to store test record entries for a ray being traced, wherein each test record entry indicates a test that may need to be performed to trace the ray; and
an allocation circuit operable to:
determine whether the ray tracing circuit may require additional storage space to store test record entries to trace a ray; and
when it is determined that the ray tracing circuit may require additional storage space to store test record entries to trace a ray:
allocate additional storage space from the storage for the ray tracing circuit to use to store test record entries to trace the ray.

2. The graphics processor of claim 1, wherein the storage includes an initial storage region reserved for the ray tracing circuit to initially use to store test record entries to trace a ray; and
the allocation circuit is operable to:
determine whether the ray tracing circuit may require additional storage space to store test record entries to trace a ray by determining whether the ray tracing circuit may require that more test record entries are stored to trace the ray than can be stored in the initial storage region for the ray; and
determine that the ray tracing circuit may require additional storage space to store test record entries to trace a ray when it is determined that the ray tracing circuit may require that more test record entries are stored to trace the ray than can be stored in the initial storage region for the ray.

3. The graphics processor of claim 2, wherein the initial storage region can only store fewer test record entries than a maximum possible number of test record entries that the ray tracing circuit can require are stored to trace a ray.

4. The graphics processor of claim 1, wherein the ray tracing circuit is operable to trace a group of plural rays together, and the storage includes an allocatable storage region reserved for the allocation circuit to allocate for the ray tracing circuit to use to store test record entries to trace any ray of the group of plural rays.

5. The graphics processor of claim 4, wherein the allocation circuit is operable to allocate the allocatable storage region as a whole.

6. The graphics processor of claim 4, wherein the allocation circuit is operable to allocate parts of the allocatable storage region.

7. The graphics processor of claim 1, wherein the allocation circuit is operable to determine whether the ray tracing circuit may require additional storage space to store test record entries to trace a ray by:
determining whether a maximum number of test record entries that can be stored for the ray are being stored; and
determining that the ray tracing circuit may require additional storage space to store test record entries to trace a ray when it is determined that a maximum number of test record entries that can be stored for the ray are being stored.

8. The graphics processor of claim 1, wherein the allocation circuit is operable to determine whether the ray tracing circuit may require additional storage space to store test record entries to trace a ray by:
determining whether a maximum number of test record entries that can be stored for the ray are being stored;
when it is determined that a maximum number of test record entries that can be stored for the ray are being stored:
determining whether a next operation to be performed by the ray tracing circuit to trace the ray may require that another test record entry is stored for the ray; and
determining that the ray tracing circuit may require additional storage space to store test record entries to trace a ray when it is determined that a next operation to be performed by the ray tracing circuit to trace the ray may require that another test record entry is stored for the ray.

9. The graphics processor of claim 8, wherein the allocation circuit is operable to determine whether a next operation to be performed by the ray tracing circuit to trace the ray may require that another test record entry is stored for the ray by:
determining whether the next operation is a ray-volume intersection test; and
determining that a next operation to be performed by the ray tracing circuit to trace the ray may require that another test record entry is stored for the ray when it is determined that the next operation is a ray-volume intersection test.

10. The graphics processor of claim 1, wherein the allocation circuit is operable to:
determine whether the ray tracing circuit requires that fewer test record entries are stored to trace a ray than can be stored for the ray; and
when it is determined that the ray tracing circuit requires that fewer test record entries are stored to trace a ray than can be stored for the ray:
deallocate storage space that the ray tracing circuit was using to trace the ray.

11. The graphics processor of claim 1, wherein the ray tracing circuit is operable to use the storage to store a stack of test record entries.

12. The graphics processor of claim 11, wherein the storage comprises registers and RAM, and the ray tracing circuit is operable to use the registers to store the top entry of the stack and to use the RAM to store other entries of the stack.

13. A method of operating a graphics processor that is operable to perform ray tracing, wherein the graphics processor comprises:
storage; and
a ray tracing circuit operable to trace rays by performing tests to determine whether the rays intersect geometry representing a scene to be rendered, wherein the ray tracing circuit is operable to use the storage to store test record entries for a ray being traced, wherein each test record entry indicates a test that may need to be performed to trace the ray;
the method comprising:
determining whether the ray tracing circuit may require additional storage space to store test record entries to trace a ray; and
when it is determined that the ray tracing circuit may require additional storage space to store test record entries to trace a ray:
allocating additional storage space from the storage for the ray tracing circuit to use to store test record entries to trace the ray.

14. The method of claim 13, comprising:
providing an initial storage region of the storage that is reserved for the ray tracing circuit to initially use to store test record entries to trace a ray;
determining whether the ray tracing circuit may require additional storage space to store test record entries to trace a ray by determining whether the ray tracing circuit may require that more test record entries are stored to trace the ray than can be stored in the initial storage region for the ray; and
determining that the ray tracing circuit may require additional storage space to store test record entries to trace a ray when it is determined that the ray tracing circuit may require that more test record entries are stored to trace the ray than can be stored in the initial storage region for the ray.

15. The method of claim 14, wherein the initial storage region can only store fewer test record entries than a maximum possible number of test record entries that the ray tracing circuit can require are stored to trace a ray.

16. The method of claim 13, wherein the ray tracing circuit is operable to trace a group of plural rays together, and the method comprises:
providing an allocatable storage region of the storage that is reserved for allocation for the ray tracing circuit to use to store test record entries to trace any ray of the group of plural rays.

17. The method of claim 13, comprising determining whether the ray tracing circuit may require additional storage space to store test record entries to trace a ray by:
determining whether a maximum number of test record entries that can be stored for the ray are being stored; and
determining that the ray tracing circuit may require additional storage space to store test record entries to trace a ray when it is determined that a maximum number of test record entries that can be stored for the ray are being stored.

18. The method of claim 13, comprising determining whether the ray tracing circuit may require additional storage space to store test record entries to trace a ray by:
determining whether a maximum number of test record entries that can be stored for the ray are being stored;
when it is determined that a maximum number of test record entries that can be stored for the ray are being stored:
determining whether a next operation to be performed by the ray tracing circuit to trace the ray may require that another test record entry is stored for the ray; and
determining that the ray tracing circuit may require additional storage space to store test record entries to trace a ray when it is determined that a next operation to be performed by the ray tracing circuit to trace the ray may require that another test record entry is stored for the ray.

19. The method of claim 13, comprising:
determining whether the ray tracing circuit requires that fewer test record entries are stored to trace a ray than can be stored for the ray; and
when it is determined that the ray tracing circuit requires that fewer test record entries are stored to trace a ray than can be stored for the ray:
deallocating storage space that the ray tracing circuit was using to trace the ray.

20. A non-transitory computer readable storage medium storing software code which when executing on a processor performs a method of operating a graphics processor that is operable to perform ray tracing, wherein the graphics processor comprises:
storage; and
a ray tracing circuit operable to trace rays by performing tests to determine whether the rays intersect geometry representing a scene to be rendered, wherein the ray tracing circuit is operable to use the storage to store test record entries for a ray being traced, wherein each test record entry indicates a test that may need to be performed to trace the ray;
the method comprising:
determining whether the ray tracing circuit may require additional storage space to store test record entries to trace a ray; and
when it is determined that the ray tracing circuit may require additional storage space to store test record entries to trace a ray:
allocating additional storage space from the storage for the ray tracing circuit to use to store test record entries to trace the ray.
